(19) United States
(12) Patent Application Publication
(10) Pub. No.: US 2008/0222262 A1
(43) Pub. Date: Sep. 11, 2008

(54) Digital Album Service System for Showing Digital Fashion Created by Users and Method for Operating the Same

(75) Inventors: Uk Oh, Seoul (KR); Jae Chul Kim, Seoul (KR); Jang Hoon Lee, Incheon (KR); Du Hwan Yeo, Seoul (KR); Jin Young Lee, Seoul (KR); Jeong Wook Suh, Gyeonggi-do (KR); In Chul Kang, Seoul (KR); Jung Hwan Lee, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SK C&C CO. LTD., Seongnam-si (KR)

(21) Appl. No.: 12/088,232

(22) PCT Filed: Aug. 23, 2006
(86) PCT No.: PCT/KR2006/003318

§ 371 Date: Mar. 26, 2008

(30) Foreign Application Priority Data
Sep. 30, 2005 (KR) 10-2005-0091813
Jun. 1, 2006 (KR) 10-2006-0049273

(51) Int. Cl. G06F 15/16; G06F 17/00

(52) U.S. Cl. 709/206

(57) ABSTRACT

A system and method provide mobile services of a fashion album directly created by a user. A digital album service system and method provide wireless mobile services, wherein figures of a user's avatar wearing a variety of fashion items are provided in the form of a moving picture to a user connected to an avatar image server through a wired communication network using a personal computer (PC). A relevant image is provided in the form of a still picture and/or a mobile flash to a specific mobile communication terminal selected by the user, thereby allowing the user to view or download the image without restriction of time and space.

### TECHNICAL FIELD

The present invention relates to a system and method for providing mobile services of a digital album directly created by a user, and more particularly, to a digital fashion album service system and method for providing wireless mobile services, wherein figures of a user's avatar wearing a variety of fashion items are provided in the form of a moving picture to a user connected to an avatar image server through a wired communication network using a personal computer (PC), and a relevant image is provided in the form of a still picture and/or a mobile flash picture to a specific mobile communication terminal selected by the user, thereby allowing the user to view or download the image without restriction of time and space.

### BACKGROUND ART

With advancements in communication technologies, use of the wireless Internet through a variety of mobile communication terminals such as mobile phones has been recently increased. Accordingly, mobile contents services provided through mobile communication networks are widely employed as much as the existing web contents services provided through wired communication networks.

Such mobile contents services are provided in such a way that a user connects to a website provided by a specific contents provider (CP) using a user's own mobile communication terminal to hear audio data such as bell sounds or MP3 files or view image data such as photographs or moving pictures or to download the data to his/her own mobile terminal, if desired.

In particular, a mobile fashion photo service allows users to immediately view apparel collections of famous fashion designers, fashion photos of famous stars, or the like through a mobile communication terminal without restriction of time and space, so that the general public can easily have access to the latest fashion trends of fashion items including apparel.

However, such a mobile fashion photo service has a problem in that the figures of famous stars or fashion models wearing fashion items are merely shown, and thus, it is difficult for a user to choose a product suitable for himself/herself.

Meanwhile, as young people recently have a strong desire for individuality or self-expression, a market of the user created contents (UCC) services in which multimedia contents created by themselves such as photographs or moving pictures can be shared with the other people has been rapidly expanded, instead of the conventional methods of passively receiving contents that are one-sidedly provided by web contents providers.

In such a user created contents service, a user created mobile fashion album service is required in which three-dimensional avatar images are created by scanning a user in a three-dimensional (3D) way and a user puts fashion items such as apparel on his/her own avatar and experiences in a virtual environment whether the fashion items are well suitable for the user, so that the user who utilizes an avatar creation system can store the figures of an avatar wearing a variety of fashion items suitable for the user in the form of an image and can view or receive the stored images through a mobile communication terminal of a user or his/her friend.

### DISCLOSURE OF INVENTION

### Technical Problem

Accordingly, the present invention is conceived to solve the aforementioned problems in the prior art. It is an object of the present invention to provide a mobile fashion album service system and method, wherein figures of a user's avatar wearing a variety of fashion items are provided in the form of a moving picture to a user connected to an avatar image server through a wired communication network using a personal computer (PC), and a corresponding image is provided in the form of a still picture or a mobile flash to a specific mobile communication terminal selected by the user, thereby allowing the user to view or download the image without restriction of time and space.

### Technical Solution

According to an aspect of the present invention for achieving the object, there is provided a digital album service system for showing digital fashions directly created by a user, which comprises a user PC, an avatar image server connected to the user PC through the Internet to provide a figure of a user's avatar wearing a variety of fashion items in the form of a moving picture, an SMS server connected to the avatar image server through the Internet to transmit a callback SMS to a specific mobile communication terminal in response to a request from the avatar image server, and a mobile server connected to the avatar image server and the user PC through the Internet to receive an image of an avatar wearing an item and provide the image to the mobile communication terminal connected through a mobile communication network in response to the callback SMS.

Further, there is provided a method of providing user created fashion album services, which comprises the steps of: creating and displaying, by the avatar image server, an image of a user's avatar wearing a fashion item using user's 3D avatar information and selected fashion item information in response to a request from a user connected through the Internet; receiving, by the avatar image server, from the user who has viewed the image of the avatar wearing the selected item, whether to provide the relevant image to a mobile communication terminal to perform a mobile service; capturing, by a user PC, the relevant image to create a still picture or moving picture capture image file, if it is determined to provide the image in the step of receiving whether to provide the image; receiving, through the user PC, from the user a phone number of a mobile communication terminal of a receiver to whom the relevant image is transmitted; transmitting, by the user PC, to the mobile server the image file created in the step of creating a capture image file and the phone number received in the step of receiving a phone number; transmitting, by the SMS server, a callback SMS including callback URL information to the mobile communication terminal in response to a request from the avatar image server; connecting, by the mobile communication terminal which has received the callback SMS, to the mobile server; and providing, by the mobile server, mobile services to the connected mobile communication terminal to allow the user to view an image of an avatar wearing an item in the form of a fashion album or download the image.

### Advantageous Effects

The digital album service system and method for showing digital fashions directly created by a user according to the present invention have an advantage in that a user provides a mobile communication terminal with a variety of images in which his/her own avatar wears a variety of fashion items, and thus, a user-oriented mobile fashion album can be provided.

Further, if the present invention is applied to an on-line shopping mall, a mobile fashion album can be provided in advance to an acquaintance's mobile communication terminal, before a user buys a specific product, such that the user can take an advice on the product from the acquaintance. Therefore, there is another advantage in that the user can be induced to buy a product more economically.

### BRIEF DESCRIPTION OF THE DRAWINGS

FIG. 1 is a block diagram showing the configuration of a user created digital album service system according to an embodiment of the present invention.

FIG. 2 is a flowchart illustrating a user created digital album service method according to an embodiment of the present invention.

FIG. 3 is a flowchart illustrating in further detail a process of providing mobile services shown in FIG. 2.

FIG. 4 is an exemplary view showing that a mobile communication terminal receiving a callback SMS receive a relevant service in response to the callback SMS in the step of transmitting the callback SMS shown in FIG. 2.

### BEST MODE FOR CARRYING OUT THE INVENTION

Hereinafter, a preferred embodiment of the present invention will be described in greater detail with reference to the accompanying drawings.

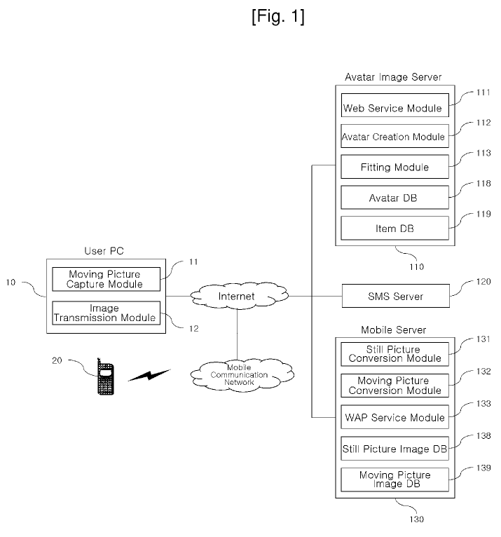

FIG. 1 is a block diagram showing the configuration of a digital album service system for showing digital fashions directly created by a user according to an embodiment of the present invention.

As shown in FIG. 1, the digital album service system for showing digital fashions directly created by a user according to an embodiment of the present invention comprises a user PC 10, an avatar image server 110 connected to the user PC 10 via the Internet to provide figures of a user's avatar wearing a variety of fashion items in the form of a moving picture, an SMS server 120 connected to the avatar image server 110 via the Internet to transmit a callback SMS to a specific mobile communication terminal 20 in response to a request from the avatar image server 110, and a mobile server 130 connected to the avatar image server 110 and the user PC 10 via the Internet to receive an image of an avatar wearing a desired fashion item and to provide the relevant image to the mobile communication terminal 20 connected through a mobile communication network in response to the callback SMS.

The avatar image server 110 comprises an avatar creation module 112 for creating three-dimensional avatar images from pattern data obtained by scanning a user's body using a 3D scanner, an avatar database (DB) 118 for storing the 3D avatar images created by the avatar creation module 112, an item DB 119 for storing information on a variety of fashion items, such as apparel and accessories, which are put on a user's avatar, a fitting module 113 for retrieving fashion item information stored in the item DB 119 according to a user's selection and creating figures of a user's avatar wearing the retrieved fashion items in the form of a moving picture, and a web service module 111 for providing avatar-based image creation services to a user of a PC connected through the Internet in cooperation with the avatar creation module and the fitting module.

Here, the avatar creation module 112 receives face pattern data from the 3D scanner to create a 3D face image of the user, displays a plurality of 3D body images previously stored in the avatar DB 118 through a screen of the user PC and combines the face image with a 3D body image selected from the plurality of three-dimensional body images to create a 3D avatar image.

The user PC 10 comprises a moving picture capture module 11 for capturing a moving picture received from the avatar image server 110 and creating an image file, and an image transmission module 12 for transmitting the image file created in the moving picture capture module 11 to the mobile server 130.

Here, the moving picture capture module 11 and the image transmission module 12 are ActiveX-based application programs that are automatically transmitted to and installed in the user PC 10 when the user PC 10 initially connects to the avatar image server 110. Hereinafter, a process of operating the programs will be briefly described.

A user connected to the avatar image server 110 views avatar-based images wearing an item outputted to the user PC 10 by the avatar image server 110 and selects a menu such as “Provide Image” provided by the avatar image server 110 if the user wants the fashion item put on the avatar. Then, the moving picture capture module 11 is driven within the user PC 10 to create an image file by capturing the relevant image. Next, if the user inputs the phone number of a mobile communication terminal to which the user wishes to provide the relevant image, the image transmission module 12 is driven to transmit the created image file to the mobile server 130 together with the inputted phone number.

In this manner, the operations of capturing an image of an avatar wearing a desired item using an avatar and transmitting the image to the mobile server 130 are performed in the user PC 10, rather than in the avatar image server 110. Thus, the operating loads of the avatar imager server 110 can be greatly reduced.

The image files created by the moving picture capture module 11 are classified into an image file of a still picture captured at a specific time selected by the user or an image file of a moving picture including a plurality of images sequentially captured for a predetermined time period. If the moving picture image file is set to capture ten frames per second for ten seconds, a total of one hundred image files are created. Here, the image file is a file compressed according to a still picture compression standard, such as Joint Photographic Expert Group (JPEG), which is preferably in the form of a file that can improve an image transmission rate.

If the user wishes to provide an image of his/her own avatar wearing a specific fashion item through a mobile service, the callback SMS is transmitted to a mobile communication terminal 20 selected by the user in response to a request from the avatar image server 110. In such a case, the callback SMS contains uniform resource locator (URL) information of the mobile server 130 to which the mobile communication terminal 20 can connect to receive mobile fashion album services.

The mobile server 130 comprises a still picture image DB 138 and a moving picture image DB 139 for storing the transmitted still picture image files and moving picture image files, respectively, together with the phone number information of a mobile communication terminal 20 to which a relevant image file is provided; a still picture conversion module 131 and/or a moving picture conversion module 132 for retrieving an image file associated with the phone number of the connected mobile communication terminal 20 from the still picture image DB 138 or the moving picture image DB 139 and converting the retrieved image file into a still picture or a mobile flash picture; and a wireless application protocol (WAP) service module 133 for providing mobile services using WAP to the connected mobile communication terminal 20 in cooperation with the still picture conversion module 131 and the moving picture conversion module 132.

The WAP service module 133 requests terminal information from the mobile communication terminal 20 when the mobile communication terminal 20 connects to the callback URL and receives information such as screen resolution of the terminal and whether the terminal can play back a mobile flash. A wireless protocol language such as wireless markup language (WML) can be utilized to receive the terminal information from the mobile communication terminal 20.

The still picture conversion module 131 and the moving picture conversion module 132 create a still picture and a moving picture, respectively, which are optimized to the corresponding terminal with reference to the received terminal information, i.e. the screen resolution of the terminal or the like.

Here, only if the mobile communication terminal 20 can play back a mobile flash, it is preferred that the moving picture conversion module 132 create a mobile flash picture and the WAP service module 133 provide a menu through which a flash picture can be viewed or downloaded.

Although it has been described above that the moving picture capture module 11 and the image transmission module 12 are configured to be installed in the user PC 10 to capture an image file from an avatar-based picture wearing an item provided by the avatar image server 110 and transmit the captured image file to the mobile server 130, the moving picture capture module 11 and the image transmission module 12 may be provided in the avatar image server 110 rather than in the user PC 10, so that the avatar image server 110 can directly capture an image file from a moving picture and transmit the image file to the mobile server 130.

In addition, the present invention may be configured in such a manner that the mobile server 130 does not comprise the still picture image DB 138 and the moving picture image DB 139 but stores the received still picture image files and moving picture image files in a hard disk in the form of a file on the hard disk such that the stored files can be automatically deleted after a predetermined time period, for example, three months.

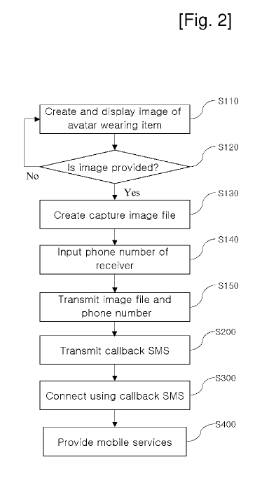

Hereinafter, a method of providing digital album services showing digital fashions directly created by a user, using the system so configured, according an embodiment of the present invention will be described in detail with reference to FIG. 2.

First, the avatar image server 110 creates an image of a user's avatar wearing a desired fashion item using user's 3D avatar information and selected fashion item information in response to a request from a user connected through the Internet, and displays the created image onto the user PC 20 (step S110).

Here, a process of creating an avatar image in this step will be described in detail.

The avatar creation module 112 of the avatar image server 110 determines whether the 3D avatar information provided by the user is face pattern data or whole body pattern data of the user. If it is determined to be the face pattern data of the user, the avatar creation module 112 applies the face pattern data to an avatar creation algorithm and creates a 3D face image corresponding to the user's face.

Then, the avatar creation module 112 retrieves 3D body images from the avatar DB 118 and displays the retrieved image onto a display device.

If any one of the displayed 3D body images is selected, the avatar creation module 112 combines the selected 3D body image with the 3D face image to create a user's 3D avatar image, and then displays the avatar image onto the display device simultaneously when storing the created avatar image in the avatar DB 118. At this time, the body images stored in the avatar DB 118 become 3D body images.

On the other hand, if the 3D avatar information is the whole body pattern data of the user, the avatar creation module 112 applies the whole body pattern data to the avatar creation algorithm to create a 3D avatar image of the user and displays the created 3D avatar image onto the display device simultaneously while storing the avatar images in the avatar DB 118.

Here, the avatar image server 110 provides a list of various fashion items to the user, retrieves the user's 3D avatar information and specific fashion item information from the avatar DB 118 and the item DB 119, and creates a figure of a user's avatar wearing a specific fashion item in the form of a moving picture. In addition, the user can view the figure of the avatar wearing the specific item displayed on the user PC 10 from various angles through the operation of a mouse or keyboard and can also view the figure of an avatar dynamically walking as in the fashion show.

Thereafter, the avatar image server 110 receives, from the user who has viewed the figure of an avatar wearing a specific item, whether to provide the corresponding image to the mobile communication terminal and to provide mobile services (step S120). If the user does not wish to provide the image, the process returns to the step of creating and displaying an image of avatar wearing an item (step S110) such that the user can again select another fashion item. If the user wishes to provide the image, a corresponding image is captured in the user PC 10 to create a capture image file for a still picture or moving picture (step S130).

Then, the user PC 10 receives from the user the phone number of a receiver's mobile communication terminal 20 to which the corresponding image will be transmitted (step S140) and transmits the image file created in the step S130 of creating a capture image and the phone number received in the step S140 of inputting a phone number to the mobile server 130 (step S150).

Here, in the step S 130 of creating a capture image and the step S150 of transmitting an image file and a phone number, the operation of creating and transmitting a capture image is performed by driving the moving picture capture module 11 and the image transmission module 12, which are installed in the user PC 10, in response to a request from the avatar image server 110.

In addition, if an image file and a phone number are transmitted through the step S150 of transmitting an image file and a phone number, the mobile server 130 allows the received information to be stored in the still picture image DB 138 and the moving picture image DB 139, respectively.

If the step S150 of transmitting an image file and a phone number is completed, the avatar image server 110 requests SMS transmission to the SMS server 120 which in turn transmits a callback SMS including callback URL information to the mobile communication terminal 20 (step S200).

Then, if the user of the mobile communication terminal 20 that has received the callback SMS connects to the mobile server 130 by pressing a wireless Internet connection button (step S300), the mobile server 130 provides mobile services to the connected mobile communication terminal 20 to allow the user to view images of avatar wearing a desired item in the form of a fashion album or to download the images (step S400).

Here, as described above, if the moving picture capture module 11 and the image transmission module 12 are provided in the avatar image server 110 rather than in the user PC 10, the avatar image server 110 directly creates a capture image file and transmits the image file and a phone number to the mobile server 130 in the step S130 of creating a capture image and the step S150 of transmitting an image file and a phone number.

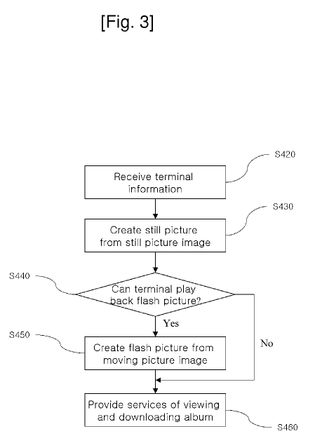

Hereinafter, the above step of providing mobile services will be described in further detail with reference to FIG. 3.

First, the mobile server 130 transmits a WML script to a connected mobile communication terminal 20 to accordingly receive terminal information such as the screen resolution of the terminal and whether flash moving pictures can be played back (step S420).

Then, with reference to the received terminal information, the mobile server 130 retrieves a still picture image stored in the still picture image DB 138 in the step S150 of transmitting an image file and creates a still picture optimized to the resolution of the relevant terminal (step S430).

In addition, the mobile server 130 determines whether the relevant terminal can play back a mobile flash moving picture based on the received terminal information (step S440). If it is determined that the terminal can play back a mobile flash, the mobile server retrieves a moving picture image stored in the moving picture image DB 139 in the step S150 of transmitting an image file and creates a mobile flash picture that can be played back in the relevant terminal (step S450).

Finally, the mobile server 130 provides the connected mobile communication terminal 20 with a menu screen through which a fashion album containing still pictures and mobile flash pictures can be viewed or specific images can be downloaded (step S460). An example of the menu screen displayed on the mobile communication terminal 20 will be described in detail later.

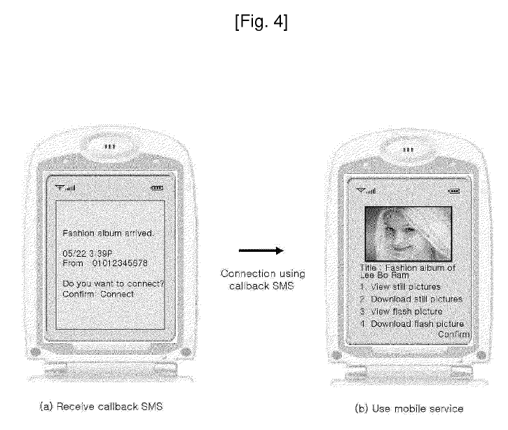

FIG. 4 is a view showing an example of screen in which a mobile communication terminal receiving a callback SMS receives a relevant service in response to the callback SMS in the step of transmitting the callback SMS shown in FIG. 2.

If the mobile communication terminal confirms the callback SMS transmitted from the SMS server in the step S200 of transmitting the callback SMS, the arrival of a fashion album is notified and whether to connect to the mobile server is simultaneously inquired as shown in FIG. 4(a).

If the user of the mobile communication terminal selects a confirm menu in response to the above inquiry, the mobile communication terminal connects to the callback URL included in the callback SMS, and an initial screen of a menu provided by the mobile server in the step S460 of providing services for viewing and/or downloading an album is displayed on the display of the mobile communication terminal as shown in FIG. 4(b). Here, the user of the mobile communication terminal can view or download still pictures through the “View Still Pictures” and “Download Still Pictures” menus and can view or download moving pictures through the “View Moving Pictures” and “Download Moving Pictures” menus.

Meanwhile, although the present invention has been described with reference to the specific preferred embodiments and illustrated in cooperation with the accompanying drawings, the present invention is not limited thereto. It will be readily understood by those skilled in the art that various substitutions, modifications and changes can be made thereto without departing from the spirit and scope of the present invention defined by the appended claims.

### INDUSTRIAL APPLICABILITY

In the digital album service system and method for showing digital fashions directly created by a user according to the present invention, a mobile communication network can be interconnected with an Internet network, and thus, both an additional service business of a mobile communication company and an Internet-based electronic commerce field can be advanced together.

1. A digital album service system for showing digital fashions directly created by a user, comprising:
a user PC (10);
an avatar image server (110) connected to the user PC (10) through the Internet to provide a figure of a user's avatar wearing a variety of fashion items in the form of a moving picture;
an SMS server (120) connected to the avatar image server (110) through the Internet to transmit a callback SMS to a specific mobile communication terminal (20) in response to a request from the avatar image server (110); and
a mobile server (130) connected to the avatar image server (110) and the user PC (10) through the Internet to receive an image of an avatar wearing an item and provide the image to the mobile communication terminal (20) connected through a mobile communication network in response to the callback SMS.

2. The system as claimed in claim 1, wherein the avatar image server comprises:
an avatar creation module (112) for creating three-dimensional (3D) avatar images from pattern data obtained by scanning a user's body using a 3D scanner;
an avatar database (DB) (118) for storing the 3D avatar images created by the avatar creation module (112);
an item DB (119) for storing information on a variety of fashion items including apparel, accessories and the like which are put on the user's avatar;
a fitting module (113) for retrieving fashion item information stored in the item DB (119) according to a user's selection and creating a figure of a user's avatar wearing the retrieved fashion items in the form of a moving picture; and
a web service module (111) for providing avatar-based image creation services to a user of a PC connected through the Internet in cooperation with the avatar creation module and the fitting module, and the user PC comprises:
a moving picture capture module (11) for capturing a moving picture received from the avatar image server (110) to create an image file; and
an image transmission module (12) for transmitting to the mobile server (130) the image file created by the moving picture capture module (11).

3. The system as claimed in claim 1, wherein the avatar image server comprises:
an avatar creation module (112) for creating three-dimensional (3D) avatar images from pattern data obtained by scanning a user's body using a 3D scanner;
an avatar database (DB) (118) for storing the 3D avatar images created by the avatar creation module (112);
an item DB (119) for storing information on a variety of fashion items including apparel, accessories and the like which are put on the user's avatar;
a fitting module (113) for retrieving fashion item information stored in the item DB (119) according to a user's selection and creating a figure of a user's avatar wearing the retrieved fashion items in the form of a moving picture;
a web service module (111) for providing avatar-based image creation services to a user of a PC connected through the Internet in cooperation with the avatar creation module and the fitting module;
a moving picture capture module (11) for capturing a moving picture created in the fitting module (113) to create an image file; and
an image transmission module (12) for transmitting the image file created by the moving picture capture module (11) to the mobile server (130).

4. The system as claimed in claim 3, wherein the avatar creation module (112) receives face pattern data from the 3D scanner to create a 3D face image of the user, displays a plurality of 3D body images previously stored in the avatar DB (118) through a screen of the user PC, and combines the face image with a 3D body image selected from the plurality of 3D body images to create a 3D avatar image.

5. The system as claimed in any one of claims 1 to 3, wherein the mobile server (130) comprises:
a still picture image DB (138) for storing a transmitted still picture image file together with information on a phone number of a mobile communication terminal (20) to which a relevant image file is provided;
a moving picture image DB (139) for storing a transmitted moving picture image file together with information of a phone number of a mobile communication terminal (20) to which a relevant image file is provided;
a still picture conversion module (131) for retrieving an image file associated with the phone number of the connected mobile communication terminal (20) from the still picture image DB (138) and converting the retrieved image file into a still picture;
a moving picture conversion module (132) for retrieving an image file associated with the phone number of the connected mobile communication terminal (20) from the moving picture image DB (139) and converting the retrieved image file into a mobile flash picture; and
a wireless application protocol (WAP) service module (133) for providing mobile services using WAP to the connected mobile communication terminal (20) in cooperation with the still picture conversion module (131) and the moving picture conversion module (132).

6. The system as claimed in claim 5, wherein the WAP service module requests terminal information from the mobile communication terminal and receives information including screen resolution of the terminal, whether a mobile flash can be played back in the terminal, or the like, when the mobile communication terminal connects to the callback URL.

7. A method of providing user created fashion album services using a system including an avatar image server for creating a figure of an avatar wearing an item, a mobile server and an SMS server, the method comprising the steps of:
creating and displaying, by the avatar image server, an image of a user's avatar wearing a fashion item using user's 3D avatar information and selected fashion item information in response to a request from a user connected through the Internet;
receiving, by the avatar image server, from the user who has viewed the image of the avatar wearing the selected item, whether to provide the relevant image to a mobile communication terminal to perform a mobile service;
capturing, by a user PC, the relevant image to create a still picture or moving picture capture image file, if it is determined to provide the image in the step of receiving whether to provide the image;
receiving, through the user PC, from the user a phone number of a mobile communication terminal of a receiver to whom the relevant image is transmitted;
transmitting, by the user PC, to the mobile server the image file created in the step of creating a capture image file and the phone number received in the step of receiving a phone number;
transmitting, by the SMS server, a callback SMS including callback URL information to the mobile communication terminal in response to a request from the avatar image server;
connecting, by the mobile communication terminal which has received the callback SMS, to the mobile server; and
providing, by the mobile server, mobile services to the connected mobile communication terminal to allow the user to view an image of an avatar wearing an item in the form of a fashion album or download the image.

8. The method as claimed in claim 7, wherein the step of capturing the relevant image to create a still picture or moving picture capture image file is performed by driving a moving picture capture module previously installed in the user PC in response to a request from the avatar image server.

9. The method as claimed in claim 7, wherein the step of transmitting the capture image file and the phone number is performed by driving an image transmission module previously installed in the user PC in response to a request from the avatar image server.

10. A method of providing user created fashion album services using a system including an avatar image server for creating a figure of an avatar wearing an item, a mobile server and an SMS server, the method comprising the steps of:
creating and displaying, by the avatar image server, an image of a user's avatar wearing a fashion item using user's 3D avatar information and selected fashion item information in response to a request from a user connected through the Internet;
receiving, by the avatar image server, from the user who has viewed the image of the avatar wearing the selected item, whether to provide the relevant image to a mobile communication terminal to perform a mobile service;
capturing, by the avatar image server, the relevant image to create a still picture or moving picture capture image file, if it is determined to provide the image in the step of receiving whether to provide the image;
receiving, through the user PC, from the user a phone number of a mobile communication terminal of a receiver to whom the relevant image is transmitted;
transmitting, by the avatar image server, to the mobile server the image file created in the step of creating a capture image file and the phone number received in the step of receiving a phone number;
transmitting, by the SMS server, a callback SMS including callback URL information to the mobile communication terminal in response to a request from the avatar image server;
connecting, by the mobile communication terminal which has received the callback SMS, to the mobile server; and
providing, by the mobile server, mobile services to the connected mobile communication terminal to allow the user to view an image of an avatar wearing an item in the form of a fashion album or download the image.

11. The method as claimed in claim 7 or 10, wherein the step of creating and displaying an image of an avatar wearing a fashion item comprises the steps of:
providing a list of various fashion items to the user;
retrieving user's 3D avatar information and specific fashion item information from an avatar DB and an item DB, respectively;
creating a figure of a user's avatar wearing a specific fashion item in the form of a moving picture by combining the retrieved avatar information and specific fashion item information; and
displaying the relevant moving picture on the user PC.

12. The method as claimed in claim 7 or 10, wherein the step of providing mobile services comprises the steps of:
waiting for a callback connection from the mobile communication terminal which has received the callback SMS in the step of transmitting a callback SMS; receiving terminal information of the mobile communication terminal which has connected to the mobile server;
creating a still picture optimized to a resolution of the relevant mobile communication terminal from the stored still picture images with reference to the received terminal information;
determining whether the relevant terminal can play back a mobile flash moving picture based on the received terminal information;
creating a mobile flash picture, which can be played back in the relevant terminal, from the stored moving picture images, if it is determined, in the step of determining whether the terminal can play back a mobile flash, that the terminal can play back a mobile flash moving picture; and
providing the mobile communication terminal with a menu screen through which the created still picture and/or mobile flash picture can be viewed or a desired picture can be downloaded.
